(19) United States
(12) Patent Application Publication
(10) Pub. No.: US 2022/0179920 A1
(43) Pub. Date: Jun. 9, 2022

(54) METHOD FOR MONITORING A HYDROSTATIC BEARING THAT IS IN OPERATION AND A MONITORING SYSTEM

(71) Applicant: NATIONAL FORMOSA UNIVERSITY, YUN-LIN COUNTY (TW)

(72) Inventors: TZU-CHI CHAN, YUN-LIN COUNTY (TW); JIA-HONG YU, YUN-LIN COUNTY (TW); YU-PING HONG, YUNG-LIN COUNTY (TW)

(21) Appl. No.: 17/114,807

(22) Filed: Dec. 8, 2020

(51) Int. Cl. G06F 17/15; G06F 17/14; G01M 13/04

(52) U.S. Cl. CPC G06F 17/156; F16C 41/00; G01M 13/04; G06F 17/142

(57) ABSTRACT

A method for monitoring a hydrostatic bearing that is in operation is provided. Frequency domain analysis, time domain analysis and principal components analysis are performed on an operation signal that results from the operation of the hydrostatic bearing, so as to build a Gaussian mixture model. Then, based on a difference between the Gaussian mixture model and a predetermined reference model, an operation state of the hydrostatic bearing can be determined in real time.

### FIELD

The disclosure relates to a monitoring method for a machine tool, and more particularly to a method for monitoring a hydrostatic bearing that is in operation.

### BACKGROUND

Hydrostatic bearings that are used in machine tools are filled with fluid to support the bearings. Hydrostatic bearings may encounter problems, such as deflection of the bearings, non-uniformity of the fluid in terms of temperature or pressure, etc., during operation of the bearings. These problems may lower the precision of processing.

To solve these problems, a conventional method is to manually check the state of the hydrostatic bearings and perform manual calibration when the hydrostatic bearings are shut down, which may prolong the entire processing time and thus increase the production cost.

### SUMMARY

Therefore, an object of the disclosure is to provide a method that can monitor a parameter related to a hydrostatic bearing that is in operation, so as to determine whether the hydrostatic bearing is operating normally.

According to the disclosure, the method for monitoring a hydrostatic bearing that is in operation is provided to be implemented by a monitoring system.

The monitoring system includes a parameter acquisition module electrically connected to the hydrostatic bearing, a storage module storing a predetermined reference model and a predetermined threshold that are related to the hydrostatic bearing, and a computation module electrically connected to the parameter acquisition module and the storage module. The method includes: A) by the parameter acquisition module, acquiring an operation signal that is related to operation of the hydrostatic bearing during an operation period in which the hydrostatic bearing is in operation, the operation signal including a plurality of parameter values that respectively correspond to multiple time points in the operation period; B) by the computation module, transforming the operation signal from time domain to frequency domain, and performing frequency domain analysis on the operation signal thus transformed to obtain a plurality of frequency-domain eigenvalues; C) by the computation module, performing time domain analysis on the operation signal to obtain a plurality of time-domain eigenvalues; D) by the computation module, performing principal components analysis on the frequency-domain eigenvalues and the time-domain eigenvalues to obtain a plurality of analysis data pieces that respectively correspond to multiple principal components obtained from the principal components analysis, each of the analysis data pieces including a plurality of analysis eigenvalues; E) by the computation module, for each of the analysis data pieces, building a Gaussian model based on the analysis eigenvalues of the analysis data piece; F) by the computation module, performing linear superposition on the Gaussian models built for the analysis data pieces to obtain a Gaussian mixture model; G) by the computation module, acquiring a difference between the Gaussian mixture model and the predetermined reference model that is stored in the storage module; and H) by the computation module, generating a monitoring result that indicates an operation state of the hydrostatic bearing based on the difference and the predetermined threshold that is stored in the storage module.

Another object of the disclosure is to provide a monitoring system that implements the method of this disclosure.

According to the disclosure, the monitoring system adapted for monitoring a hydrostatic bearing that is in operation includes a parameter acquisition module, a storage module and a computation module. The parameter acquisition module is electrically connected to the hydrostatic bearing, and is configured to acquire an operation signal that is related to operation of the hydrostatic bearing during an operation period in which the hydrostatic bearing is in operation. The operation signal includes a plurality of parameter values that respectively correspond to multiple time points in the operation period. The storage module stores a predetermined reference model and a predetermined threshold which are related to the hydrostatic bearing. The computation module is electrically connected to the parameter acquisition module and the storage module, and is configured to: (i) transform the operation signal from time domain to frequency domain, (ii) perform frequency domain analysis on the operation signal thus transformed to obtain a plurality of frequency-domain eigenvalues, (iii) perform time domain analysis on the operation signal to obtain a plurality of time-domain eigenvalues, (iv) perform principal components analysis on the frequency-domain eigenvalues and the time-domain eigenvalues to obtain a plurality of analysis data pieces that respectively correspond to multiple principal components obtained from the principal components analysis, each of the analysis data pieces including a plurality of analysis eigenvalues, (v) for each of the analysis data pieces, build a Gaussian model based on the analysis eigenvalues of the analysis data piece, (vi) perform linear superposition on the Gaussian models built for the analysis data pieces to obtain a Gaussian mixture model, (vii) acquire a difference between the Gaussian mixture model and the predetermined reference model that is stored in the storage module, and (viii) generate a monitoring result that indicates an operation state of the hydrostatic bearing based on the difference and the predetermined threshold that is stored in the storage module.

### BRIEF DESCRIPTION OF THE DRAWINGS

Other features and advantages of the disclosure will become apparent in the following detailed description of the embodiment(s) with reference to the accompanying drawings, of which:

FIG. 1 is a block diagram illustrating a monitoring system adapted to implement an embodiment of a method for monitoring a hydrostatic bearing that is in operation according to the disclosure;

FIG. 2 is a flow chart illustrating steps of the embodiment;

FIG. 3 is a flow chart illustrating operations of step (B) of the embodiment;

FIG. 4 is a plot exemplarily illustrating a result of principal components analysis;

FIG. 5 is a flow chart illustrating operations of step (E) of the embodiment; and

FIG. 6 is a flow chart illustrating operations of step (H) of the embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

In order to fulfill the demands for high precision of processing and promote overall operation efficiency, hydrostatic bearings are widely used in many parts of machines. When hydrostatic bearings are in operation, the resultant vibration thereof may influence the precision in processing workpieces.

This disclosure provides a monitoring system to instantly monitor and diagnose the operation of a hydrostatic bearing. The monitoring system may be used with a cloud system so that personnel who are in charge of the operation of the machine that uses the hydrostatic bearing can locally or remotely obtain operation information of the hydrostatic bearing in real time in order to predict problems that may occur on the hydrostatic bearing in the future, and promote the overall production efficiency of the machine. In this disclosure, signals that are related to operation of the hydrostatic bearing are acquired for principal components analysis to obtain desired eigenvalues. Then, normalized eigenvalues are used to establish a model that can be used to analyze a state of health for the hydrostatic bearing.

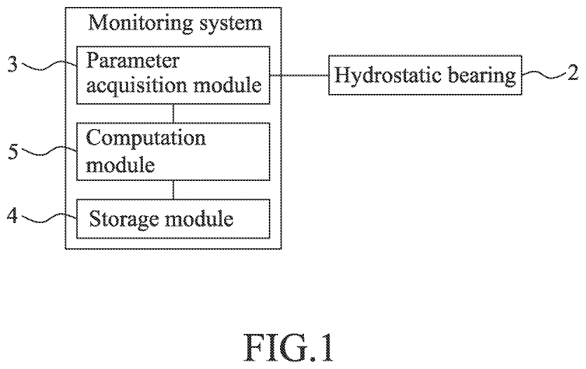

FIG. 1 exemplifies a monitoring system adapted for implementing an embodiment of a method for monitoring a hydrostatic bearing 2 that is in operation according to this disclosure. The monitoring system includes a parameter acquisition module 3, a storage module 4 and a computation module 5.

The parameter acquisition module 3 is electrically connected to the hydrostatic bearing 2, and is configured to acquire an operation signal that is related to operation of the hydrostatic bearing 2. In this embodiment, the parameter acquisition module 3 includes an accelerometer (not shown) for acquiring variation of vibration that results from operation of the hydrostatic bearing 2, so as to generate the operation signal. In other embodiments, the parameter acquisition module 3 may include other types of sensing components to acquire parameters that are related to operation of the hydrostatic bearing 2, such as electric current, fluid amount, fluid pressure, temperature variation, etc., and this disclosure is not limited in this respect

The storage module 4 stores a predetermined reference model and a predetermined threshold that are related to the hydrostatic bearing 2, and can be realized as, for example, a hard disk drive, a solid state drive, a flash memory module, or the like.

The computation module 5 is electrically connected to the parameter acquisition module 3 and the storage module 4. The computation module 5 may include a microcontroller or a controller (not shown) such as, but not limited to, a single core processor, a multi-core processor, a dual-core mobile processor, a microprocessor, a microcontroller, a digital signal processor (DSP), a field-programmable gate array (FPGA), an application specific integrated circuit (ASIC), a radio-frequency integrated circuit (RFIC), etc., which is programmed or designed to perform the embodiment of this disclosure.

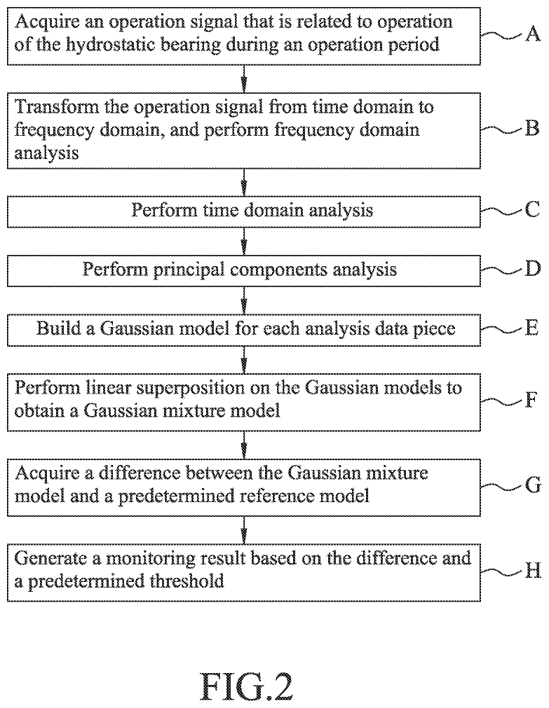

Further referring to FIG. 2, the embodiment of the method for monitoring a hydrostatic bearing 2 that is in operation according to this disclosure includes a parameter acquisition step (A), a frequency-domain analysis step (B), a time-domain analysis step (C), a principal components analysis step (D), a modeling step (E), a model mixture step (F), a comparing step (G) and a result generation step (H).

In the parameter acquisition step (A), the parameter acquisition module 3 acquires the operation signal that is related to operation of the hydrostatic bearing 2 during an operation period in which the hydrostatic bearing 2 is in operation. The operation signal includes a plurality of parameter values that respectively correspond to multiple time points in the operation period. In this embodiment, the operation signal may include a plurality of vibration magnitude values that serve as the parameter values. In this embodiment, the operation period may be, for example, 100 seconds long, and the parameter acquisition module 3 may acquire the operation signal with a bandwidth of 2560 Hz, but this disclosure is not limited to such.

In the frequency-domain analysis step (B), the computation module 5 transforms the operation signal from time domain to frequency domain, and performs frequency domain analysis on the operation signal thus transformed to obtain a plurality of frequency-domain eigenvalues.

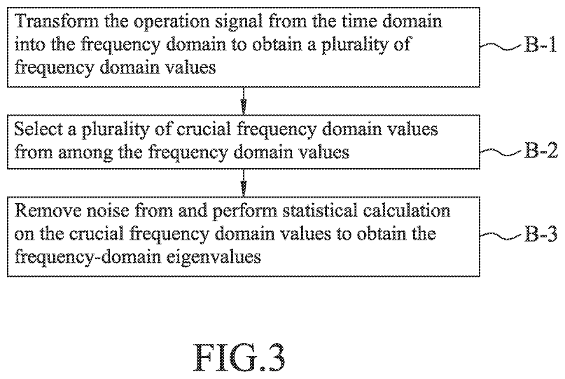

Referring to FIGS. 1 through 3, the frequency-domain analysis step (B) includes a transforming operation (B-1), a selecting operation (B-2), and an eigenvalue generating operation (B-3).

In the transforming operation (B-1), the computation module 5 transforms the operation signal from the time domain into the frequency domain to obtain a plurality of frequency domain values using, for example, fast Fourier transform (FFT), but this disclosure is not limited in this respect.

In the selecting operation (B-2), the computation module 5 selects a plurality of crucial frequency domain values from among the frequency domain values.

In this embodiment, the computation module 5 calculates a main frequency based on a rotational speed of the hydrostatic bearing 2 and a number of cutters that are brought into operation by the hydrostatic bearing 2. As an example, assuming that the rotational speed of the hydrostatic bearing 2 is 300 rpm and the hydrostatic bearing 2 brings a cutter into operation (i.e., the number of the cutters that are brought into operation by the hydrostatic bearing 2 is one), the main frequency can calculated as being 300/60×1=5 (Hz). Then, the computational module 5 makes those of the frequency domain values that respectively corresponding to frequencies that are one to thirty times the main frequency (e.g., 5 Hz×2=10 Hz (two times the main frequency), 5 Hz×3=15 Hz (three times the main frequency), 5 Hz×4=20 Hz (four times the main frequency), etc., for the given example) serve as the crucial frequency domain values.

In the eigenvalue generating operation (B-3), the computation module 5 removes noise from and performs statistical calculation on the crucial frequency domain values to obtain the frequency-domain eigenvalues. In this embodiment, the computation module 5 uses the Kalman filter to remove noise from the crucial frequency domain values and then performs outlier processing (statistical calculation) using, for example, a z-score processing to filter out outliers of the crucial frequency domain values, so as to obtain the frequency-domain eigenvalues.

Referring to FIGS. 1 and 2 again, in the time-domain analysis step (C), the computation module 5 performs time domain analysis on the operation signal to obtain a plurality of time-domain eigenvalues. In this embodiment, the time-domain eigenvalues may include at least two of a kurtosis value, a root-mean-square (RMS) value, a crest factor value, a skewness value, a standard deviation value or a variance value of the parameter values of the operation signal, but this disclosure is not limited in this respect.

The kurtosis value (K) of the parameter values can be calculated according to:

$$K = \frac{\frac{1}{n} {{\sum }_{i = 1}}^{n} {( {x}_{i} - \overline{x} )}^{4}}{{( \frac{1}{n} {\sum }_{i = 1}^{n} {( {x}_{i} - \overline{x} )}^{2} )}^{2}} - 3$$

where n represents a number of the parameter values, xᵢ represents an it one of the parameter values, and x̅ represents an average of the parameter values.

The RMS value (M) of the parameter values can be calculated according to:

$$M = \frac{\sqrt{{\sum }_{i = 1}^{n} {x}_{i}^{2}}}{n}$$

where n represents a number of the parameter values, and xᵢ represents an i^{th} one of the parameter values.

The crest factor value (C) of the parameter values can be calculated according to:

$$C = \frac{\vert {x}_{peak} \vert}{{x}_{rms}}$$

where |xₚₑₐₖ| represents a maximum value of absolute values of the parameter values, and xᵣₘₛ represents the RMS value of the parameter values.

The skewness value (S) of the parameter values can be calculated according to:

$$S = \frac{\frac{1}{n} {\sum }_{i = 1}^{n} {( {x}_{i} - \overline{x} )}^{3}}{{( \frac{1}{n} {\sum }_{i = 1}^{n} {( {x}_{i} - \overline{x} )}^{2} )}^{2 / 3}}$$

where n represents a number of the parameter values, xᵢ represents an i^{th} one of the parameter values, and x̅ represents an average of the parameter values.

The standard deviation value (σ) of the parameter values can be calculated according to:

$$σ = \sqrt{\frac{1}{n} {\sum }_{i = 1}^{n} {( {x}_{i} - \overline{x} )}^{2}}$$

where n represents a number of the parameter values, xᵢ represents an it one of the parameter values, and x̅ represents an average of the parameter values.

The variance value of the parameter values is the square of the standard deviation value of the parameter values.

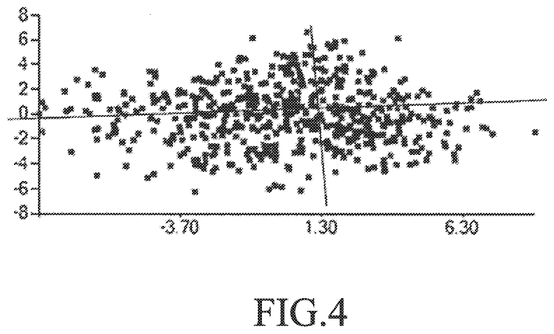

In the principal components analysis step (D), the computation module 5 performs principal components analysis on the frequency-domain eigenvalues and the time-domain eigenvalues to obtain a plurality of analysis data pieces that respectively correspond to multiple principal components obtained from the principal components analysis, where each of the analysis data pieces includes a plurality of analysis eigenvalues. In this embodiment, this step can be performed using commercially available software of, for example, xxxxx, but this disclosure is not limited in this respect. FIG. 4 exemplarily shows a distribution of a plurality of data points each representing one of the frequency-domain eigenvalues and the time-domain eigenvalues. The two straight lines in FIG. 4 represent two of the principal components obtained using the principal components analysis. Those of the data points that are crossed by a straight line serve as the analysis eigenvalues of one of the analysis data pieces that corresponds to a principal component represented by the straight line.

In the modeling step (E), for each of the analysis data pieces, the computation module 5 builds a Gaussian model based on the analysis eigenvalues of the analysis data piece.

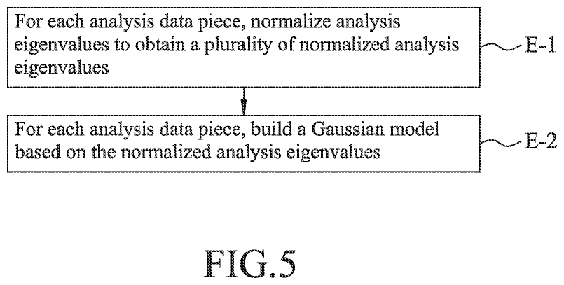

Further referring to FIG. 5, the modeling step (E) includes a normalization operation (E-1) and a model building operation (E-2)

In the normalization operation (E-1), for each of the analysis data pieces, the computation module 5 normalizes the analysis eigenvalues thereof to obtain a plurality of normalized analysis eigenvalues. Normalization of an i^{th} one of the analysis eigenvalues can be performed according to:

$${y}_{norm} = \frac{{y}_{i} - {y}_{min}}{{y}_{max} - {y}_{min}} ∈ [ 0 , 1 ]$$

where yᵢ represents the i^{th} one of the analysis eigenvalues, yₘᵢₙ represents the smallest one of the analysis eigenvalues, and yₘₐₓ represents the greatest one of the analysis eigenvalues.

In the model building operation (E-2), for each of the analysis data pieces, the computation module 5 builds a Gaussian model based on the normalized analysis eigenvalues obtained for the analysis data piece. In this embodiment, for each of the analysis data pieces, the computation module 5 builds the Gaussian model based on an average and a variance of the normalized analysis eigenvalues obtained for the analysis data piece.

Referring to FIGS. 1 and 2 again, in the model mixture step (F), the computation module 5 performs linear superposition on the Gaussian models built for the analysis data pieces to obtain a Gaussian mixture model. In particular, the computation module 5 uses a Gaussian mixture model (GMM) algorithm to perform the linear superposition on the Gaussian models. A probability density function of the Gaussian mixture model can be represented by:

$$p ( x ) = {\sum }_{i = 1}^{k} {α}_{i} {g}_{i} ( x ; {μ}_{i} , {σ}_{i}^{2} )$$

where:

$${\sum }_{i = 1}^{k} {α}_{i} = 1 ;$$

$${g}_{i} ( x ; {μ}_{i} , {\sum }_{i} ) \frac{1}{{( 2 π )}^{1 / 2} {σ}_{i}} {e}^{{D}_{i}} ;$$

$${D}_{i} = - \frac{1}{2 {σ}_{i}^{2}} {( x - {μ}_{i} )}^{T} ( x - {μ}_{i} ) ;$$

k represents a number of the Gaussian models obtained in the modeling step (E);

αᵢ represents a mixture weight;

gᵢ(x;μᵢ,Σᵢ) represents an i^{th} one of the Gaussian models;

μᵢ represents a center of the i^{th} one of the Gaussian models, namely, the average of the normalized analysis eigenvalues of the i^{th} one of the analysis data pieces that corresponds to the i^{th} one of the Gaussian models; and

σᵢ² represents a variance of the i^{th} one of the Gaussian models, namely, the variance of the normalized analysis eigenvalues of the i^{th} one of the analysis data pieces.

In the comparing step (G), the computation module 5 acquires a difference between the Gaussian mixture model and the predetermined reference model. In this embodiment, the predetermined reference model is a Gaussian mixture model obtained by performing steps (A) through (F) using a reference hydrostatic bearing that is deemed normal during operation. In this embodiment, the difference between the Gaussian mixture model and the predetermined reference model is a non-overlap rate between the Gaussian mixture model and the predetermined reference model (i.e., equaling 1 minus overlap_rate). The method of obtaining the overlap rate between the Gaussian mixture model and the predetermined reference model can be referenced to an article by Haojun Sun & Shengrui Wang, entitled “Measuring the component overlapping in the Gaussian mixture model” and published in Computer Science Data Mining and Knowledge Discovery, 2011, so details thereof are omitted herein for the sake of brevity. In other embodiments, the difference may be a “distance” between the Gaussian mixture model and the predetermined reference model. However, this disclosure is not limited in the way to acquire the difference.

In the result generation step (H), the computation module 5 generates a monitoring result that indicates an operation state of the hydrostatic bearing 2 based on the difference and the predetermined threshold that is stored in the storage module 4.

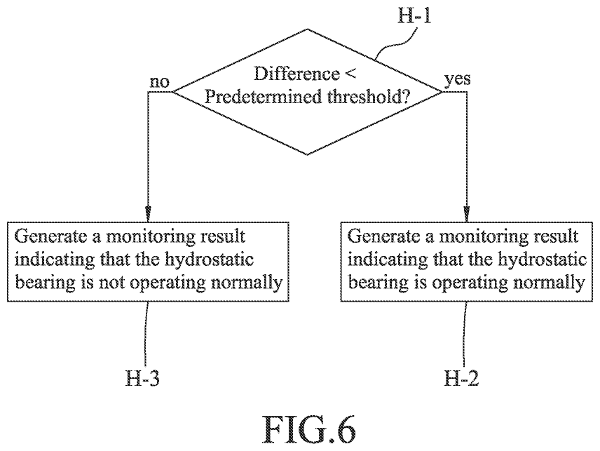

Referring to FIG. 6, the result generation step (H) includes a determining operation (H-1), a first result generation operation (H-2) and a second result generation operation (H-3).

In the determining operation (H-1), the computation module 5 determines whether the difference is smaller than the predetermined threshold. The flow goes to the first result generation operation (H-2) when affirmative, and goes to the second result generation operation (H-3) when otherwise.

In the first result generation operation (H-2), the computation module 5 generates a monitoring result indicating that the hydrostatic bearing 2 is operating normally.

In the second result generation operation (H-3), the computation module 5 generates a monitoring result indicating that the hydrostatic bearing 2 is not operating normally.

When the hydrostatic bearing 2 is determined as not operating normally in the result generation step (H), the operator of the machine that uses the hydrostatic bearing 2 may take necessary actions, such as stopping operation of the machine and calibrating the hydrostatic bearing 2, so as to minimize adverse effects that would result from the abnormal operation.

In summary, the embodiment of the method for monitoring the hydrostatic bearing 2 according to this disclosure uses the parameter acquisition module 3 to acquire the operation signal, and uses the computation module 5 to perform frequency domain analysis, time domain analysis and principal components analysis on the operation signal, so as to build a Gaussian mixture model. Then, based on the comparison between the Gaussian mixture model and the predetermined reference model, the computation module 5 that implements the embodiment can determine whether the hydrostatic bearing 2 operates normally in real time.

Furthermore, the embodiment of this disclosure is favorable to industrial upgrading. For example, the variation trend of the hydrostatic bearing 2 can be obtained from the acquired operation signal and the algorithm that is used to build the models. The data related to the trend can be monitored online in real time, and can be provided to a remote end that is able to diagnose the state of health of the machine and the hydrostatic bearing 2 using signal processing. The embodiment can be applied to a variety of fields, and can make contribution to developing intelligent machines and intelligent manufacturing.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for monitoring a hydrostatic bearing that is in operation, the method to be implemented by a monitoring system, the monitoring system including a parameter acquisition module electrically connected to the hydrostatic bearing, a storage module storing a predetermined reference model and a predetermined threshold that are related to the hydrostatic bearing, and a computation module electrically connected to the parameter acquisition module and the storage module, said method comprising steps of:
A) by the parameter acquisition module, acquiring an operation signal that is related to operation of the hydrostatic bearing during an operation period in which the hydrostatic bearing is in operation, the operation signal including a plurality of parameter values that respectively correspond to multiple time points in the operation period;
B) by the computation module, transforming the operation signal from time domain to frequency domain, and performing frequency domain analysis on the operation signal thus transformed so as to obtain a plurality of frequency-domain eigenvalues;
C) by the computation module, performing time domain analysis on the operation signal to obtain a plurality of time-domain eigenvalues;
D) by the computation module, performing principal components analysis on the frequency-domain eigenvalues and the time-domain eigenvalues to obtain a plurality of analysis data pieces that respectively correspond to multiple principal components obtained from the principal components analysis, each of the analysis data pieces including a plurality of analysis eigenvalues;
E) by the computation module, for each of the analysis data pieces, building a Gaussian model based on the analysis eigenvalues of the analysis data piece;
F) by the computation module, performing linear superposition on the Gaussian models built for the analysis data pieces, so as to obtain a Gaussian mixture model;
G) by the computation module, acquiring a difference between the Gaussian mixture model and the predetermined reference model that is stored in the storage module; and
H) by the computation module, generating a monitoring result that indicates an operation state of the hydrostatic bearing based on the difference and the predetermined threshold that is stored in the storage module.

2. The method of claim 1, wherein step B) includes:
B-1) transforming the operation signal from the time domain into the frequency domain to obtain a plurality of frequency domain values;
B-2) selecting a plurality of crucial frequency domain values from among the frequency domain values; and
B-3) removing noise from and performing statistical calculation on the crucial frequency domain values to obtain the frequency-domain eigenvalues.

3. The method of claim 2, wherein, in sub-step B-1), the transforming is performed using fast Fourier transform.

4. The method of claim 2, wherein, in sub-step B-3), the removing noise is performed using a Kalman filter, and the statistical calculation is to remove outliers of the crucial frequency domain values.

5. The method of claim 1, wherein the time-domain eigenvalues include at least two of a kurtosis value, a crest factor value, a skewness value, a root-mean-square value, a variance value or a standard deviation value of the parameter values.

6. The method of claim 1, wherein step E) includes:
E-1) for each of the analysis data pieces, normalizing the analysis eigenvalues to obtain a plurality of normalized analysis eigenvalues; and
E-2) for each of the analysis data pieces, building the Gaussian model based on the normalized analysis eigenvalues obtained for the analysis data piece.

7. The method of claim 1, wherein, in step F), the linear superposition is performed using a Gaussian mixture algorithm.

8. The method of claim 1, wherein step H) includes:
H-1) determining whether the difference is smaller than the predetermined threshold;
H-2) generating the monitoring result to indicate that the hydrostatic bearing is operating normally upon determining that the difference is smaller than the predetermined threshold; and
H-3) generating the monitoring result to indicate that the hydrostatic bearing is not operating normally upon determining that the difference is not smaller than the predetermined threshold.

9. A monitoring system adapted for monitoring a hydrostatic bearing that is in operation, said monitoring system comprising:
a parameter acquisition module that is electrically connected to the hydrostatic bearing, and that is configured to acquire an operation signal that is related to operation of the hydrostatic bearing during an operation period in which the hydrostatic bearing is in operation, the operation signal including a plurality of parameter values that respectively correspond to multiple time points in the operation period;
a storage module that stores a predetermined reference model and a predetermined threshold which are related to the hydrostatic bearing; and
a computation module that is electrically connected to said parameter acquisition module and said storage module, and that is configured to:
transform the operation signal from time domain to frequency domain,
perform frequency domain analysis on the operation signal thus transformed to obtain a plurality of frequency-domain eigenvalues,
perform time domain analysis on the operation signal to obtain a plurality of time-domain eigenvalues,
perform principal components analysis on the frequency-domain eigenvalues and the time-domain eigenvalues to obtain a plurality of analysis data pieces that respectively correspond to multiple principal components obtained from the principal components analysis, each of the analysis data pieces including a plurality of analysis eigenvalues,
for each of the analysis data pieces, build a Gaussian model based on the analysis eigenvalues of the analysis data piece,
perform linear superposition on the Gaussian models built for the analysis data pieces so as to obtain a Gaussian mixture model,
acquire a difference between the Gaussian mixture model and the predetermined reference model that is stored in said storage module, and
generate a monitoring result that indicates an operation state of the hydrostatic bearing based on the difference and the predetermined threshold that is stored in said storage module.
